(19) United States
(12) Patent Application Publication
(10) Pub. No.: US 2025/0153099 A1
(43) Pub. Date: May 15, 2025

(54) CO2 RECOVERY METHOD AND CO2 RECOVERY DEVICE

(71) Applicant: AIR WATER INC., Osaka (JP)

(72) Inventors: Takanori KAIGAWA, Osaka (JP); Junya SUENAGA, Osaka (JP); Megumi YAMANO, Osaka (JP); Masako TERAI, Osaka (JP)

(21) Appl. No.: 18/833,301

(22) PCT Filed: Jan. 24, 2023
(86) PCT No.: PCT/JP2023/002054

§ 371 Date: Jul. 25, 2024

(30) Foreign Application Priority Data
Jan. 25, 2022 (JP) 2022-009293

(51) Int. Cl. B01D 53/62; B01D 53/04; B01D 53/82; B01D 53/96

(52) U.S. Cl. CPC B01D 53/62; B01D 53/04; B01D 53/82; B01D 53/96; B01D 2257/504

(57) ABSTRACT

Provided is a CO₂ recovery method including: a heat exchange step of exchanging heat between water and a CO₂-containing target gas having a temperature of 100° C. or more to lower the temperature of the target gas to less than 100° C. and to generate water vapor from the water; an adsorption step of adsorbing, on an adsorbent, CO₂ in the target gas, the temperature of which has been lowered by the heat exchange step; a detachment step of detaching the CO₂ from the adsorbent by contacting the water vapor obtained in the heat exchange step with the adsorbent having the CO₂ adsorbed by the adsorption step, to transfer the CO₂ into the water vapor; and a separation step of separating the CO₂ from the CO₂-containing water vapor obtained in the detachment step.

### TECHNICAL FIELD

The present disclosure relates to a CO₂ recovery method and a CO₂ recovery device.

### BACKGROUND ART

In order to reduce the amount of emission of carbon dioxide (CO₂), a global warming gas, various methods have been studied to recover CO₂ from CO₂-containing target gases, such as combustion exhaust gases emitted from power plants, steel mills, and other facilities.

For example, PTL 1 (Japanese Patent Laying-Open No. 2017-56383) and PTL 2 (Japanese Patent Laying-Open No. 2010-69398) disclose a method of recovering CO₂ from a target gas by adsorbing CO₂ in the target gas onto a CO₂ adsorbent and then supplying vapor (with a lower CO₂ partial pressure than the target gas) to the adsorbent, so that CO₂ is detached from the adsorbent.

PTL 3 (Japanese Patent Laying-Open No. 2009-262086) discloses a method of using zeolite as a CO₂ adsorbent, using heat of a combustion exhaust gas to increase the temperature of the zeolite, and detaching CO₂ from the zeolite.

Also, for example, PTL 4 (Japanese Patent Laying-Open No 2018-114464) discloses a method of recovering CO₂ from a CO₂-containing gas by a pressure swing adsorption method. In the pressure swing adsorption method, CO₂ is adsorbed on and detached from an adsorbent by using the pressure difference in an adsorption tower equipped with the adsorbent.

### CITATION LIST

### Patent Literature

PTL 1: Japanese Patent Laying-Open No. 2017-56383
PTL 2: Japanese Patent Laying-Open No. 2010-69398
PTL 3: Japanese Patent Laying-Open No. 2009-262086
PTL 4: Japanese Patent Laying-Open No. 2018-114464

### SUMMARY OF INVENTION

### Technical Problem

In the methods disclosed in PTLs 1 and 2, energy is required during heating to obtain vapor. The use of this energy indirectly causes CO₂ emission, which decreases the effectiveness of reducing the amount of CO₂ emission.

Note that PTL 1 discloses that use of vapor from a volatile solvent, such as alcohol (with small evaporation heat) with small energy consumed to obtain the vapor reduces the energy consumption to obtain the vapor.

However, in order to subject CO₂ to gas-liquid separation by lowering the temperature of CO₂-containing vapor and condensing the vapor, it is desirable to use water vapor, which is easier to condense than vapor from a volatile solvent.

In addition, a heat-transfer medium for regeneration, the amount of which corresponds to the saturated vapor pressure, is contaminated in the recovered CO₂ after gas-liquid separation. This causes a heat-transfer medium loss. Therefore, the heat-transfer medium should be constantly supplied. For this reason, it is preferable to use, as a heat-transfer medium, water (water vapor) contained in the combustion exhaust gas rather than to use a separately prepared volatile solvent.

Further, the recovered CO₂ is expected to be used for various purposes. Meanwhile, water is often more acceptable as impurities contaminated in CO₂ than a volatile solvent. For example, alcohol cannot be supplied to plant houses, but water is acceptable.

For the above reasons, it is preferable to use water (water vapor) as a heat-transfer medium.

In PTL 2, water vapor is used, but the energy consumption for generating water vapor is reduced because water vapor generated in, for instance, thermal power plants is used as it is. However, the CO₂ recovery device has to be installed near water vapor-generating facilities, such as thermal power plants. This should limit the location of installing the CO₂ recovery device. In addition, it cannot be applied to facilities that do not generate water vapor, such as refuse incineration plants and boiler facilities.

Further, in PTL 3, CO₂ adsorption is inhibited by moisture adsorption because zeolite is highly hygroscopic. Here, combustion exhaust gases often contain water vapor. When zeolite is used as an adsorbent, a dehumidification mechanism, for instance, is actually required in a step before the adsorbent, unfortunately.

The heat from the combustion exhaust gas may be given zeolite. In this case, for example, as shown in FIG. 5 of PTL 3, it is necessary to provide a channel for the exhaust gas to circulate in the adsorption tower. This makes the adsorption tower structure complicated, so that the cost increases relatively, causing the problem that the size of the adsorption tower becomes larger by the size of the channel. The temperature of zeolite in contact with the exhaust gas (heat-transfer medium) channel installed in the adsorption tower is easily increased, while the temperature of zeolite away from the channel is unlikely increased.

Furthermore, when the pressure swing adsorption method as disclosed in PTL 4 is used, driving power (electric energy) such as a vacuum pump or a gas compressor is required to make CO₂ adsorbed on and detached from the adsorbent by using the pressure difference in the adsorption tower. This energy consumption indirectly causes CO₂ emission in, for instance, thermal power plants, thereby mitigating the effect of reducing the amount of CO₂ emission.

The purpose of the present disclosure is to reduce energy consumption in the CO₂ recovery method and CO₂ recovery device applied to target gases such as combustion exhaust gases emitted from various facilities.

### Solution to Problem

[1] A CO₂ recovery method including:
a heat exchange step of exchanging heat between water and a CO₂-containing target gas having a temperature of 100° C. or more to lower the temperature of the target gas to less than 100° C. and to generate water vapor from the water;
an adsorption step of adsorbing, on an adsorbent, CO₂ in the target gas, the temperature of which has been lowered by the heat exchange step;
a detachment step of detaching the CO₂ from the adsorbent by contacting the water vapor obtained in the heat exchange step with the adsorbent having the CO₂ adsorbed by the adsorption step, to transfer the CO₂ into the water vapor; and
a separation step of separating the CO₂ from the CO₂-containing water vapor obtained in the detachment step.

[2] The CO₂ recovery method as described in [1], wherein the water includes at least one of condensed water from water vapor contained in the target gas and condensed water from the water vapor used in the detachment step.

[3] The CO₂ recovery method described in [1] or [2], wherein in the separation step, the CO₂ is separated by cooling the CO₂-containing water vapor obtained in the detachment step for gas-liquid separation into condensed water and CO₂.

[4] The CO₂ recovery method described in any one of [1] to [3], wherein water vapor obtained from a start of the detachment step to a predetermined time, in the CO₂-containing water vapor obtained in the detachment step is discarded and water vapor obtained after the predetermined time is subjected to the separation step.

[5] A CO₂ recovery device used for the CO₂ recovery method described in any one of [1] to [4], including:
a heat exchanger for implementing the heat exchange step;
an adsorption tower with the adsorbent for implementing the adsorption step and the detachment step; and
a separation tool for implementing the separation step.

[6] The CO₂ recovery device described in [5], wherein the adsorption tower includes a first adsorption tower and a second adsorption tower.

### Advantageous Effects of Invention

The present disclosure can be used to reduce energy consumption in the CO₂ recovery method and CO₂ recovery device applied to target gases such as combustion exhaust gases emitted from various facilities.

### BRIEF DESCRIPTION OF DRAWINGS

FIG. 1 is a flow diagram of a CO₂ recovery method according to an embodiment of the present invention.

FIG. 2 is a schematic diagram showing an example of the configuration of a CO₂ recovery device according to an embodiment of the present invention.

### DESCRIPTION OF EMBODIMENTS

Hereinafter, the CO₂ recovery method and CO₂ recovery device according to an embodiment of the present invention will be described. However, the following description is not intended to limit the scope of the CLAIMS.

[CO₂ Recovery Method and CO₂ Recovery Device]

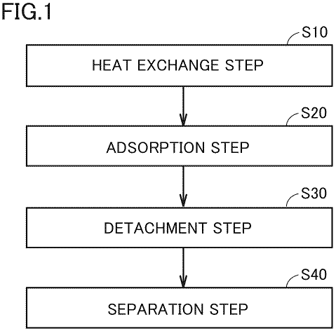

Referring to FIG. 1, the CO₂ recovery method according to this embodiment has at least a heat exchange step (S10), an adsorption step (S20), a detachment step (S30), and a separation step (S40).

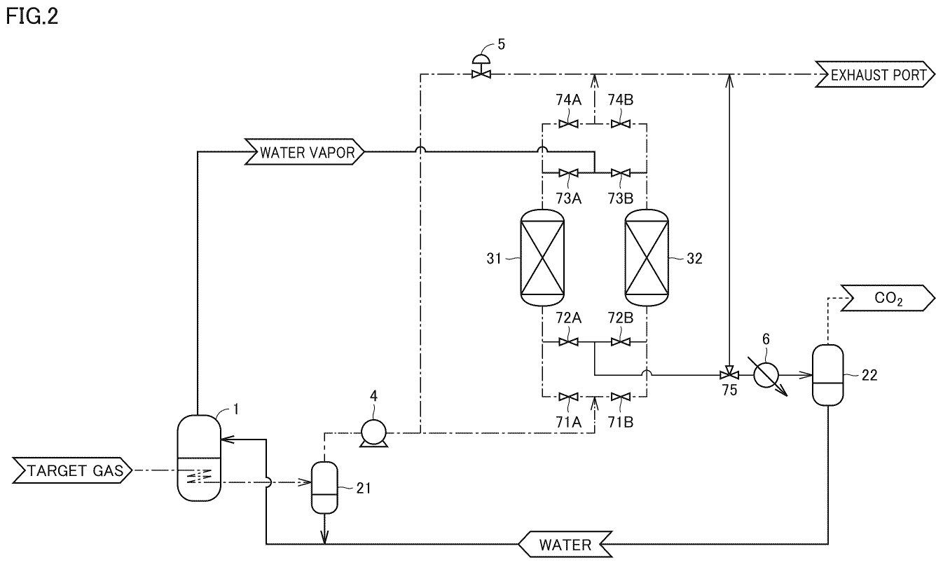

Before describing the details of the CO₂ recovery method, an example of a CO₂ recovery device used in the CO₂ recovery method according to this embodiment is briefly described with reference to FIG. 2.

The CO₂ recovery device according to this embodiment includes at least
a heat exchanger 1 for implementing the heat exchange step;
an adsorption tower with an adsorbent for implementing the adsorption step and the detachment step; and
a separation tool (e.g., a condenser 6 and a gas-liquid separator 22) for implementing the separation step.

Hereinafter, the CO₂ recovery method and CO₂ recovery device according to this embodiment will be described with reference to FIGS. 1 and 2.

<Heat Exchange Step. S10>

The heat exchange step is exchanging heat between water and a CO₂-containing target gas having a temperature of 100° C. or more to lower the temperature of the target gas to less than 100° C. and to generate water vapor from the water.

The target gas is not particularly limited as long as it contains CO₂ and has a temperature of 100° C. or more. The target gas is, for example, an exhaust gas that would be discharged directly into the atmosphere and emit CO₂ into the atmosphere if it were not used for the CO₂ recovery method of the present disclosure. Examples of such exhaust gases include combustion exhaust gases emitted from thermal power plants, boilers, etc.

The temperature of the target gas is 100° C. or more, preferably from 105 to 300° C., and more preferably from 120 to 300° C.

The level of CO₂ contained in the target gas is preferably from 1 to 20 ppm by volume and more preferably 5 to 20 ppm by volume.

In the CO₂ recovery device shown in FIG. 2, heat exchange between the target gas and water is performed in heat exchanger 1 (steam generator). Various known methods can be used as a method of generating water vapor from water by heat exchange with the target gas. For example, the method described in Japanese Patent Laying-Open No. 5-106805 can be used. Heat exchanger 1 used is not particularly limited, and may be each known heat exchanger. Examples of heat exchanger 1 include a plate heat exchanger and a double-tube heat exchanger. Note that as long as the effect of reducing overall energy consumption in the present invention is achieved, an electric heater, for instance, may be used to assist in the vaporization of water.

Such a heat exchange between the target gas and water lowers the temperature of the target gas to less than 100° C. (e.g., room temperature) and raises the temperature of the water for conversion into water vapor, causing occurrence of water vapor.

In the pressure adsorption method using a pressure difference as disclosed in PTL 4, energy is required as a power source for vacuum pumps, compressors, and others. Meanwhile, the temperature adsorption method using a temperature difference still requires energy as a heat source such as a heater for heating. Note that in PTLs 1 to 3, the reduction of this energy consumption is considered, but there is the problem mentioned above. By contrast, in the temperature adsorption method, water vapor is generated by using the target gas as a heat source in this embodiment, and this water vapor is used as a heat-transfer medium. This can reduce energy consumption, and CO₂ can be recovered for example from combustion exhaust gases emitted from various facilities.

Note that the water, which is converted to water vapor in the heat exchange step, preferably includes at least one of condensed water from water vapor contained in the target gas and condensed water from the water vapor used in the detachment step. In this case, there is no need for an external water supply for water vapor, or the amount of external water supplied can be reduced advantageously.

In the CO₂ recovery device shown in FIG. 2, the “condensed water from water vapor contained in the target gas” is obtained when the target gas contains water vapor and the target gas, the temperature of which has been lowered by heat exchange, is fed to a gas-liquid separator 21. Specifically, the target gas, the temperature of which has been lowered after passing through heat exchanger 1, is transferred from heat exchanger 1 to gas-liquid separator 21. The condensed water is then separated from the target gas in gas-liquid separator 21, and the condensed water is transferred to heat exchanger 1 and converted back into water vapor.

In the CO₂ recovery device shown in FIG. 2, the “condensed water from water vapor used in the detachment step” is obtained when CO₂-containing water vapor that has passed through the adsorption tower (a first adsorption tower 31 or a second adsorption tower 32) is fed to the separation tool (condenser 6 and gas-liquid separator 22). In other words, the condensed water separated in gas-liquid separator 22 is transferred to heat exchanger 1 and converted back into water vapor.

Note that from the viewpoint of reducing energy consumption, it is preferable to use the head (water head) of condensed water to transfer the condensed water, instead of using a liquid-sending pump, when transferring, to heat exchanger 1, moisture content (condensed water) condensed in the liquid phase by gas-liquid separator 21 and gas-liquid separator 22.

### <Adsorption Step: S20>

The adsorption step is adsorbing, on an adsorbent, CO₂ in the target gas, the temperature of which has been lowered by the heat exchange step.

In the CO₂ recovery device shown in FIG. 2, the target gas, the temperature of which has been lowered by heat exchange in heat exchanger 1, is fed by a blower 4 to the adsorption tower with an adsorbent (first adsorption tower 31 or second adsorption tower 32), where at least part of CO₂ in the target gas is adsorbed on the adsorbent.

Note that blower 4 to introduce the target gas into the adsorption tower is acceptable if a pressure can be increased corresponding to the pressure loss of piping in the CO₂ recovery device. Therefore, the energy consumption of blower 4 can also be minimized.

### (Adsorbent)

The adsorbent (CO₂ adsorbent) is not particularly limited as long as it can adsorb CO₂ contained in the target gas and allows for CO₂ detachment by water vapor. The adsorbent is preferably a porous material.

Examples of the adsorbent include activated carbon, an activated metal oxide (e.g., activated alumina, activated silica), an alkali metal-containing inorganic solid, solid amine (a solid carrying amine on a porous support), an ion exchange resin, a porous resin, a metal organic framework (MOF), and a covalent organic framework (COF). The adsorbent preferably has a high CO₂ adsorption capacity per unit volume.

The alkali metal-containing inorganic solid is an alkali metal-containing porous inorganic solid. Examples of the alkali metal contained in the alkali metal-containing inorganic solid include Na and Li. Preferred is Na.

The alkali metal-containing inorganic solid is preferably alkali metal ferrite (an oxide containing an alkali metal and iron). Examples of the alkali metal ferrite include NaFeO₂ (sodium ferrite) and LiFeO₂ (lithium ferrite). Note that CO₂ is trapped as a CO₂-containing compound by chemical reaction against an alkali metal-containing inorganic solid. Although such trapping is different from the common adsorption phenomenon, such trapping is also included in the “adsorption of CO₂ on an adsorbent” in the present disclosure.

Note that the adsorbent is preferably less-hygroscopic, and it is more preferable to use a material that practically does not adsorb moisture, or a material, from which moisture is easily detached when heated to about 100° C. This is because CO₂ adsorption is inhibited by moisture adsorption. For example, zeolite and others can adsorb CO₂ but are highly hygroscopic. Therefore, it is preferable to use, as the adsorbent, an adsorbent other than these. In particular, zeolite and others that require high temperatures for moisture detachment are not suitable as an adsorbent used in this embodiment.

Use of an adsorbent that is less sensitive to moisture (less hygroscopic) as the adsorbent circumvent installation of a dehumidification mechanism upstream of the adsorption tower. This can reduce the number of components constituting the device and energy consumption associated with dehumidification.

The shape of the adsorbent is not particularly limited, and can be, for example, a granular or honeycomb shape.

### <Detachment Step: S30>

The detachment step is detaching the CO₂ from the adsorbent by contacting the water vapor obtained in the heat exchange step with the adsorbent having the CO₂ adsorbed by the adsorption step (increasing the temperature of the adsorbent), to transfer the CO₂ into the water vapor.

In the CO₂ recovery device shown in FIG. 2, the water vapor generated in heat exchanger 1 is fed to the adsorption tower (first adsorption tower 31 or second adsorption tower 32), causing CO₂ to detach from the adsorbent and transfer the CO₂ into the water vapor.

Here, the adsorbent is heated by water vapor, and the surface temperature of the adsorbent after heating is usually the temperature or more at which CO₂ begins to detach from the adsorbent. The surface temperature of the adsorbent after heating varies depending on the type of adsorbent, and is, for example, from 60 to 200° C. and preferably from 60 to 100° C.

The adsorption tower preferably includes first adsorption tower 31 and second adsorption tower 32, as shown in FIG. 2. Provided that the number of adsorption towers is not limited to the above, and may be one, two, or more in the present disclosure.

In this case, the adsorption of CO₂ onto the adsorbent (adsorption step) and the detachment of CO₂ from the adsorbent (detachment step: regeneration of the adsorbent) are repeated alternately in each of first adsorption tower 31 and second adsorption tower 32. While the adsorption step is carried out in first adsorption tower 31, the detachment step is carried out in second adsorption tower 32. While the detachment step is, in turn, carried out in first adsorption tower 31, the adsorption step is carried out in second adsorption tower 32. This makes it possible to continuously recover CO₂ from the target gas as a whole.

Specifically, with reference to FIG. 2, for example, when valves 71B, 72A, 73A, and 74B are closed and valves 71A, 72B, 73B, and 74A are opened, the target gas (e.g., a combustion gas), the temperature of which has been lowered in heat exchanger 1, is fed to first adsorption tower 31 by blower 4, passes through first adsorption tower 31, and is exhausted. At the same time, the water vapor generated in heat exchanger 1 is fed to second adsorption tower 32, passes through second adsorption tower 32, and is then fed to the separation tool (condenser 6 and gas-liquid separator 22). As a result, the adsorption step is implemented in first adsorption tower 31, and the detachment step is implemented in second adsorption tower 32.

Next, when valves 71A, 72B, 73B, and 74A are closed and valves 71B, 72A, 73A, and 74B are opened, the target gas passes through second adsorption tower 32 and is then exhausted. At the same time, the water vapor passes through first adsorption tower 31 and is fed to the separation tool (condenser 6 and gas-liquid separator 22). As a result, the adsorption step is implemented in second adsorption tower 32, and the detachment step is implemented in first adsorption tower 31.

By switching the valves in this manner, the adsorption and detachment steps are repeated in each of first adsorption tower 31 and second adsorption tower 32. This allows for continuous CO₂ recovery form the target gas as a whole.

Note that the adsorbent that has been heated up (e.g., to about 100° C.) in the detachment step is cooled down to less than 100° C. (e.g., to room temperature) in the next adsorption step, while adsorbing CO₂ in the target gas having a temperature near room temperature, which target gas is introduced into the adsorption tower for example. When the adsorption and detachment steps are repeated, such heating and cooling of the adsorbent are repeated.

This method, in which multiple adsorption towers are used to alternately perform adsorption and detachment steps and the CO₂ is continuously recovered from the target gas by changing the temperature of the adsorbent (adsorption tower), is called the temperature swing adsorption (TSA) method. In the temperature swing adsorption method, it is preferable that the adsorption and detachment steps are carried out simultaneously in separate adsorption towers, and both steps should be carried out at the same time from the viewpoint of CO₂ recovery efficiency. Here, in the detachment step, a relatively long time is needed to sufficiently raise the temperature of the adsorbent by water vapor to detach CO₂ from the adsorbent. On the other hand, in the case of implementing the adsorption step for the same amount of time, once the amount of CO₂ adsorbed on the adsorbent reaches the upper limit, no more CO₂ is adsorbed. Therefore, in the temperature swing adsorption method using water vapor, it is preferable to use an adsorbent with a high CO₂ adsorption capacity per unit mass.

The upper limit of the amount of CO₂ adsorbed on the adsorbent (adsorption capacity) is not particularly limited, and is designed, for example, according to the amount of CO₂ supplied to the adsorption tower per cycle. Note that when the amount of CO₂ supplied to the adsorption tower per unit time is relatively small, as in the case of supplying to the adsorption tower a typical CO₂ emission source (with a CO₂ level of approx. 10%) from, for instance, a boiler or a power plant, even if the CO₂ adsorption capacity of the adsorbent is small, it is possible to detach CO₂ by sufficient heating in the other adsorption tower during one cycle.

In the detachment step in this embodiment, preferably, water vapor obtained from the start of the detachment step to a predetermined time (water vapor with low CO₂ content), of the CO₂-containing water vapor obtained in the detachment step is discarded, and water vapor (water vapor with high CO₂ content) obtained after the predetermined time is subjected to the subsequent separation step. In this case, the level of CO₂ contained in the gas to be separated and recovered in the next separation step becomes higher.

The target gas, such as a combustion exhaust gas, contains CO₂, but most of the components are other than CO₂, and are, for example, nitrogen and water vapor. After the adsorption step, voids inside the adsorption tower (including the inside pores of the adsorbent) are filled with a gas rich in these non-CO₂ components. Thus, immediately after water vapor is supplied (purged) to the adsorption tower in the detachment step, the gas in the voids of the adsorption tower is replaced (purged) by water vapor, and the gas rich in the non-CO₂ components (gas with a low CO₂ level) is discharged from the adsorption tower.

In addition, even after the gas in the voids inside the adsorption tower is discharged by the water vapor purge, the CO₂ level in the gas (water vapor) discharged from the adsorption tower is low because the amount of CO₂ detached from the adsorbent is small until the adsorbent temperature rises sufficiently.

Therefore, such a gas with a low CO₂ level as discharged from the adsorption tower at the beginning of the detachment step should be discarded, and only the gas with a high CO₂ level as discharged from the adsorption tower thereafter is subjected to the next separation step. As a result, a gas with a high CO₂ level can be obtained.

This enables efficient processing, for example, when CO₂ gas is chemically converted into CH₄, CO, etc., or when liquified carbonic acid or dry ice is produced from CO₂ gas.

In the CO₂ recovery device shown in FIG. 2, the gas with a low CO₂ level as discharged from the adsorption tower at the beginning of the separation step is discharged (discarded) from the exhaust port through branched piping by switching a three-way valve 75 installed upstream of condenser 6. This prevents the gas with a low CO₂ level from being mixed with the CO₂ (gas containing highly concentrated CO₂) that is finally recovered with the separation tool (condenser 6 and gas-liquid separator 22).

The above predetermined time is not particularly limited and may be a predetermined time or an un-predetermined time. For example, the CO₂ level in the gas (water vapor) discharged from the adsorption tower in the detachment step is monitored. While the CO₂ level is less than a prescribed threshold, the water vapor may be discarded. From the time point when the CO₂ level is the prescribed threshold or more, the water vapor may be subjected to the separation step. In addition, the same kind of monitoring may be conducted on a trial basis in advance to determine the predetermined time mentioned above; based on the predetermined time, the disposal of water vapor discharged from the adsorption tower in the detachment step may be terminated; and the timing for starting the supply of water vapor to the separation step may be thus adjusted.

Note that in PTL 1 (Japanese Patent Laying-Open No. 2017-56383), the inside of the adsorption tower equipped with the adsorbent is depressurized by a vacuum pump before the CO₂ adsorbent is heated with water vapor. This allows for the discharge of the gas rich in the non-CO₂ components present in the voids of the adsorption tower before CO₂ is detached from the adsorbent by increasing the temperature. The concentration of contaminants other than CO₂ in the gas discharged from the adsorption tower is thus reduced. However, energy for powering, for instance, a vacuum pump is required to depressurize the inside of the adsorption tower. In contrast, the present disclosure enables recovery of highly concentrated CO₂-containing gas (high-purity CO₂ gas) without using any apparatus, such as a vacuum pump, that requires a lot of energy.

Note that FIG. 2 does not necessarily show the vertical orientation of the adsorption towers (first adsorption tower 31 and second adsorption tower 32). The flow of the target gas in the adsorption step may be from the bottom to the top of the adsorption tower (up-flow) or from the top to the bottom of the adsorption tower (down-flow). Similarly, the flow of water vapor in the detachment step may be from the top to the bottom of the adsorption tower (down-flow) or from the bottom to the top of the adsorption tower (up-flow).

In addition, the direction of the target gas flow in the adsorption step and the direction of the water vapor flow in the detachment step may be opposite or the same, as shown in FIG. 2.

### <Separation Step: S40>

The separation step is separating CO₂ from the CO₂-containing water vapor obtained in the detachment step.

In the separation step, the CO₂ is preferably separated by cooling the CO₂-containing water vapor obtained in the detachment step for gas-liquid separation into condensed water and CO₂CO₂. In this case, in the CO₂ recovery device shown in FIG. 2, moisture content is liquified in condenser 6. CO₂ is then recovered from a gas phase portion of gas-liquid separator 22.

Note that the CO₂ recovery device according to this embodiment may include: a channel branching from the upstream side of valves 71A and 71B on the downstream side of blower 4 and leading to the exhaust port; and a flow control valve 5 (or an orifice or other throttling mechanism) provided at the channel.

The amount of target gas required to generate water vapor in the heat exchange step by heat exchanger 1 varies depending on the temperature of the target gas. On the other hand, the amount of target gas that can be processed for CO₂ recovery in the adsorption tower (first adsorption tower 31 and second adsorption tower 32) is limited. Thus, for example, when the temperature of the target gas decreases, the amount of the target gas supplied to heat exchanger 1 may exceed the processing capacity of the adsorption tower. In such a case, by increasing the degree of opening of flow control valve 5, the portion of the target gas that is supplied to heat exchanger 1 and exceeds the processing capacity of the adsorption tower can be exhausted from the exhaust port.

Note that depending on the properties of the target gas, a pretreatment device may be installed upstream of the adsorption tower (first adsorption tower 31 and second adsorption tower 32) in the target gas channel (at least one of the following: between heat exchanger 1 and gas-liquid separator 21, between gas-liquid separator 21 and blower 4, and between blower 4 and the adsorption tower). In this way, a trace amount of contaminants contained in the target gas may be removed. In addition, a pretreatment device may be installed in the condensed water channel between gas-liquid separator 22 and heat exchanger 1 to remove a trace amount of contaminants contained in the condensed water.

The CO₂ recovery method and CO₂ recovery device of the present disclosure described above make it possible to decrease the amount of CO₂ emission because CO₂ can be recovered from the CO₂-containing target gas while reducing energy consumption. This can reduce global warming gas emission and contribute to the realization of Sustainable Development Goals (SDGs).

### EXAMPLES

### Example 1

In the case where CO₂ is recovered from the target gas by using the CO₂ recovery device shown in FIG. 2, the CO₂ level, for instance, in the gas to be recovered was calculated by simulation.

The target gas was a gas containing 85% by volume of N₂, 5% by volume of 02, 10% by volume of CO₂, and a saturated amount of water. The adsorbent was coconut shell activated carbon (granulated; 6.5 to 10-mesh sieved). The conditions in the adsorption tower during the adsorption step were set at a temperature of 40° C. and a pressure of 10 kPaG. The conditions in the adsorption tower during the detachment step were set at a temperature of 120° C. and a pressure of 10 kPaG.

The simulation results have revealed that the gas recovered by the separation step (gas-liquid separation in gas-liquid separator 22) was a gas containing 99% by volume of CO₂, 1% by volume of N₂, and a saturated amount of water.

The embodiments and Examples disclosed herein are examples regarding every point and should not be considered to be limited. The scope of the present invention is defined by the CLAIMS but not the above description. Any modifications within the scope and the equivalent meaning of the CLAIMS are intended to be included.

### REFERENCE SINGS LIST

1 Heat exchanger; 21, 22 Gas-liquid separator; 31 First adsorption tower; 32 Second adsorption tower; 4 Blower; 5 Flow control valve; 6 Condenser; 71A. 71B, 72A, 72B, 73A, 73B, 74A, 74B Valve; 75 Three-way valve.

1. A CO₂ recovery method comprising:
a heat exchange step of exchanging heat between water and a CO₂-containing target gas having a temperature of 100° C. or more to lower the temperature of the target gas to less than 100° C. and to generate water vapor from the water;
an adsorption step of adsorbing, on an adsorbent, CO₂ in the target gas, the temperature of which has been lowered by the heat exchange step;
a detachment step of detaching the CO₂ from the adsorbent by contacting the water vapor obtained in the heat exchange step with the adsorbent having the CO₂ adsorbed by the adsorption step, to transfer the CO₂ into the water vapor; and
a separation step of separating the CO₂ from the CO₂-containing water vapor obtained in the detachment step.

2. The CO₂ recovery method according to claim 1, wherein the water comprises at least one of condensed water from water vapor contained in the target gas and condensed water from the water vapor used in the detachment step.

3. The CO₂ recovery method according to claim 1, wherein in the separation step, the CO₂ is separated by cooling the CO₂-containing water vapor obtained in the detachment step for gas-liquid separation into condensed water and CO₂.

4. The CO₂ recovery method according to claim 1, wherein water vapor obtained from a start of the detachment step to a predetermined time, of the CO₂-containing water vapor obtained in the detachment step is discarded, and water vapor obtained after the predetermined time is subjected to the separation step.

5. A CO₂ recovery device used for the CO₂ recovery method according to claim 1, comprising:
a heat exchanger for implementing the heat exchange step;
an adsorption tower with the adsorbent for implementing the adsorption step and the detachment step; and
a separation tool for implementing the separation step.

6. The CO₂ recovery device according to claim 5, wherein the adsorption tower comprises a first adsorption tower and a second adsorption tower.
